(19) United States
(12) Patent Application Publication
(10) Pub. No.: US 2016/0273557 A1
(43) Pub. Date: Sep. 22, 2016

(54) FLUID MOTION ENERGY GENERATION

(71) Applicant: Imad Mahawili, Napa, CA (US)

(72) Inventor: Imad Mahawili, Napa, CA (US)

(21) Appl. No.: 14/658,654

(22) Filed: Mar. 16, 2015

(51) Int. Cl. F15B 15/14

(52) U.S. Cl. CPC F15B 15/14

(57) ABSTRACT

An energy generation system comprises a fluid tube, a linear actuator configured to be driven by the change in fluid pressure in the fluid tube, and a generator driven by the linear actuator. A method of generating energy includes providing a fluid tube filled with a fluid, applying compression to the tube using a moving object, such as a person or a vehicle, and converting the change in pressure in the tube resulting from the compression into electricity.

### TECHNICAL FIELD AND BACKGROUND

The present invention relates to a system and method of generating electricity from moving objects, such as a human, an automobile, a train, etc.

### SUMMARY

The present invention is directed to an energy generation system and method of converting the energy in a moving object, such as a human, automobile, train, etc., into electricity via peristaltic fluid motion.

In one embodiment, an energy generation system includes a fluid tube and a linear actuator, which is driven by the change in fluid pressure in the fluid tube, and a motor generator, which is driven by the linear actuator.

In one aspect, the linear actuator comprises a fluid cylinder (also known as a fluid piston).

In a further aspect, the fluid cylinder is drivingly coupled to the generator via gearing.

In yet a further aspect, the fluid cylinder includes a drive rod with a piston drive that is configured to mesh with the gearing so that when the drive rod is extended the piston drive will drive the gearing to in turn drive the generator. For example, the piston drive may comprise a tubular or cylindrical body mounted to the cylinder's shaft. The tubular or cylindrical body may include a plurality of openings for meshing with the gearing.

According to yet a further aspect, the gearing may include a shaft with a sprocket mounted for rotation with the shaft and which also includes a gear for driving the generator.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF DRAWINGS

FIG. 1 is a schematic drawing of an energy generation system of the present invention;

FIG. 1A is a schematic drawing of a fluid tube;

FIG. 1B is a schematic drawing of the fluid tube undergoing compression over a discrete region or “sensor section”;

FIG. 2 is an enlarged top plan view of one embodiment of an energy generation apparatus of the energy generation system of FIG. 1; and

FIG. 3 is an enlarged bottom plan view of one embodiment of an energy generation apparatus of the energy generation system of FIG. 1.

### DETAILED DESCRIPTION OF PREFERRED EMBODIMENTS

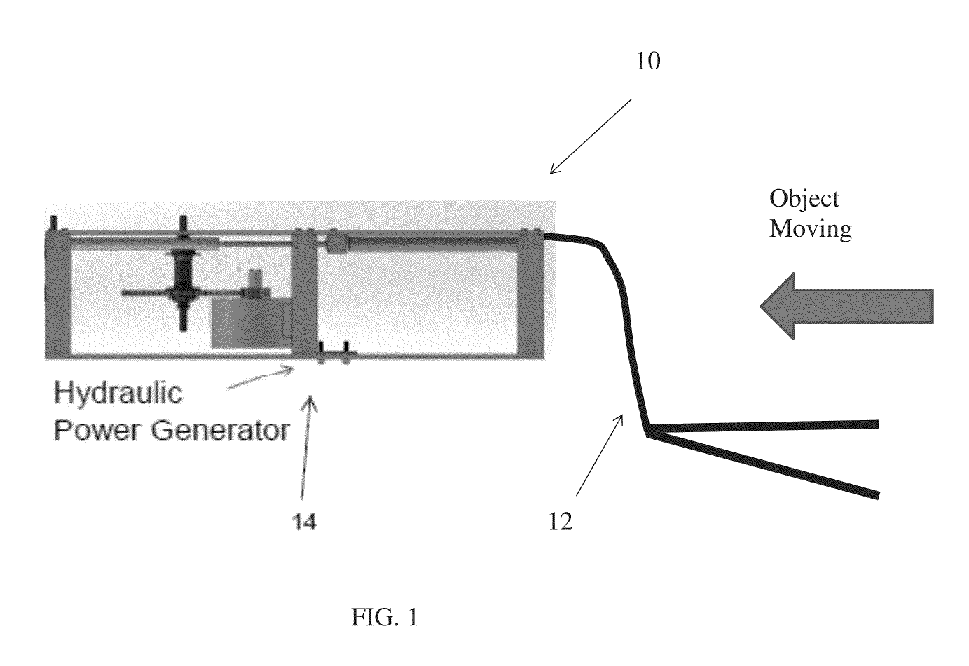

Referring to FIG. 1, the numeral 10 generally designates an energy generation system. As will be more fully described below, energy generation system 10 is configured to convert peristaltic fluid motion in a fluid tube into electricity, with the peristaltic fluid motion being induced by repeated compression of the fluid tube. For example, the tube may be placed in the path of a person or a vehicle (or other moving objects) so that when the tube is traversed, the tube will be compressed, which will generate a change in pressure in the fluid (such as air, gas, water, or hydraulic fluid) contained in the tube to generate a fluid force at the end of the tube.

As best seen in FIG. 1, system 10 includes a fluid tube 12 and a fluid power motor generator 14. Fluid tube 12 may comprise an abrasion resistant rubber tube and can be selected with a variety of internal and external diameters depending on the specific application. For example, the diameter range can vary from a fraction of an inch of the capillary tubes to several inches in internal diameter with a 0.25 inch to 0.5 inch is most suitable for general application. Suitable fluids are commercially available and selected to withstand a large variety of temperature ranges, from −40 F to +260 F or a wider range depending on local application, and pressures up to 1500 psi. The fluid tube is connected to the fluid power motor generator, which includes a fluid cylinder that is fluid communicator with the fluid in the fluid cylinder so that when the fluid force (the peristaltic “press” motion force) is generated, the cylinder will be driven by the fluid force.

Referring to FIGS. 1A and 1B, when a moving object rolls over or otherwise compresses tube 12, which is filled with a suitable fluid, the tube is squeezed locally as shown and the internal pressure increases to generate an internal fluid force—in other words, the fluid transfers the perpendicular “pressing” down force horizontally and linearly in the direction shown. As noted, the moving object may be a human foot, a car tire, or a train wheel or other moving equipment.

The cylinder, such as a fluid cylinder, including a hydraulic fluid cylinder, or pneumatic cylinder, can be selected with an internal spring return action or without. Alternately, an external return action spring can be selected or incorporated. The cylinder will extend linearly when the fluid transfer the peristaltic “press” motion force of the object, e.g. a car tire, as long as the object remains in contact with the tubular section, for example, in the road. When the car tire clears the fluid tube, then the spring will return the internal fluid to its normal starting pressure (or condition).

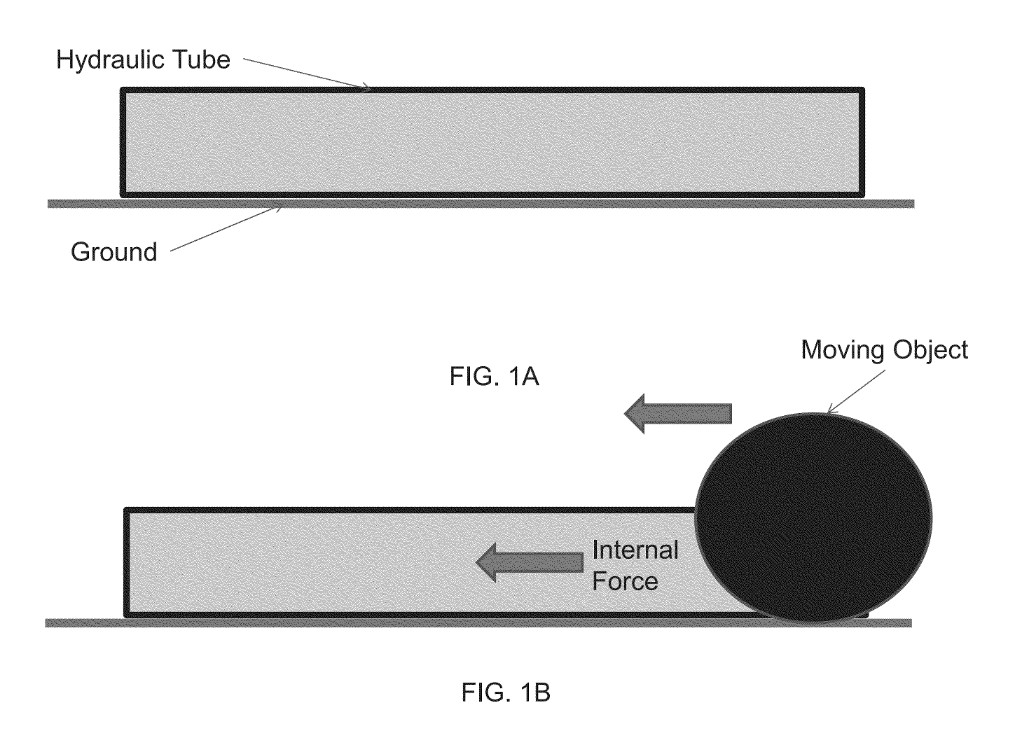

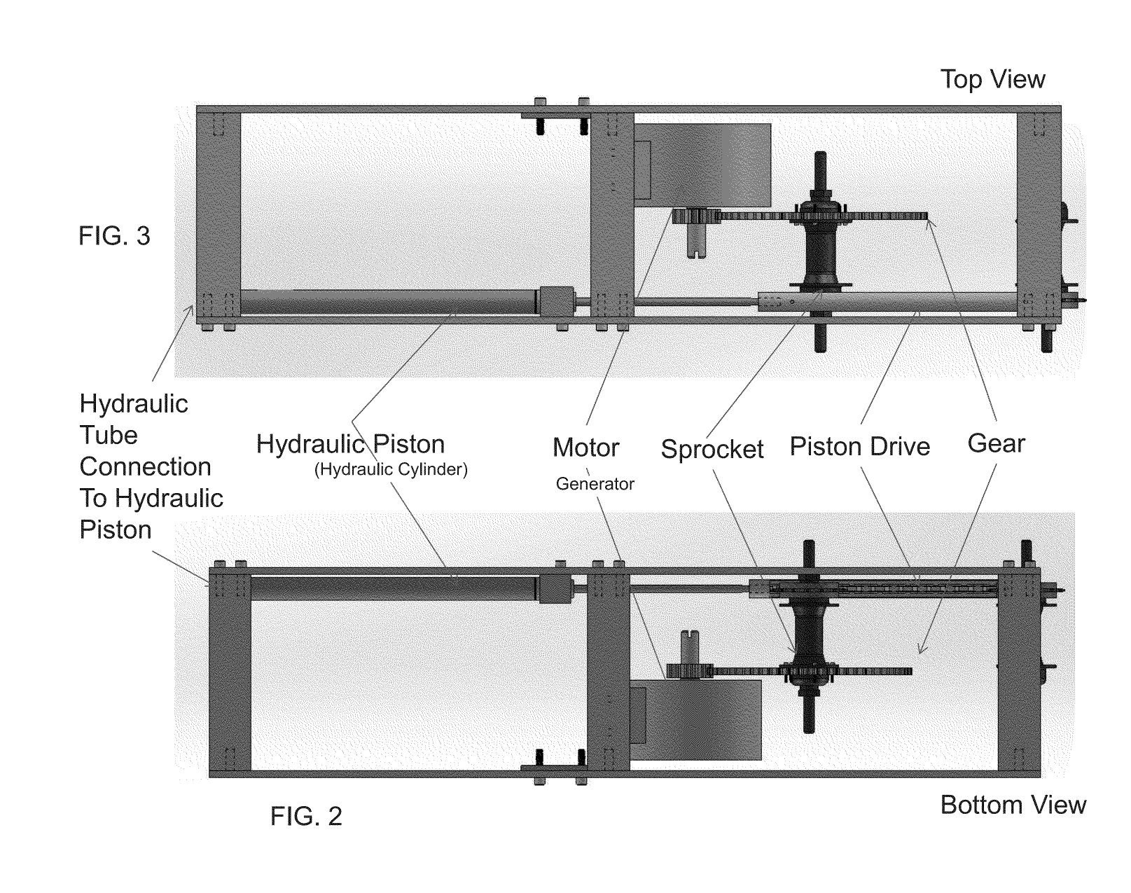

Referring to FIGS. 2 and 3, the piston shaft of the cylinder is connected to a linear piston drive. In the illustrated embodiment, the linear piston drive comprises a tubular or cylindrical body with a plurality of openings that are sized and shaped to receive the teeth of the gearing. Thus, the linear piston drive thus resembles that of a continuous chain drive.

As best seen in FIGS. 2 and 3, the gearing includes a first driven sprocket that extends into the openings provided on the linear piston drive. The driven sprocket is mounted on a shaft that supports a drive gear that engages a driven gear on the generator shaft. Thus, as linear piston drive moves linearly, the driven sprocket will be driven along with the shaft to thereby rotate the gear that drives the gear on the generator shaft. The sprocket is attached in a manner in a horizontal axis as shown and can only rotate the shaft in a clockwise direction—the power stroke. The sprocket is mounted to allow a counterclockwise “slip” so that the piston drive can return to its start position to allow for reload. The shaft of the sprocket then drives the gear that engages the generator gear with each successive force generated by the fluid tube.

The gear diameter is selected to optimize the energy transfer from the fluid force into the motor generator. The ratio can vary depending on the specific application but typically a 5 to 1 ratio is good for basic applications.

Referring again to FIG. 1, tube 12, as noted, connects to power motor generator 14, such as a fluid power motor generator. Once the fluid tube is properly filled, the angle of application may be selected for maximum energy transfer from a linearly moving object. The length of the fluid tube and the “sensor section” (where the force can be applied) can by selected to optimize the linear energy transfer from the moving object. Such lengths can vary from one foot to twenty or thirty feet depending on the mass and speed of the object. For example, a ten foot fluid tube sensor section may be suitable for a car traveling at approximately 25 miles per hour. As noted, the angle of application can also be varied and optimized depending on the specific application, mass, and speed of the object.

Further, multiple fluid tubes may be used in one energy extraction zone. Each fluid tube may be used in series or in parallel with each driving a sprocket connected to the motor generator driving gear mechanism. Fluid tube bundles can also be made on pad areas: rectangular, tubular, square, or other optimal geometries for the specific application.

Thus, a method is provided for converting peristaltic fluid motion into electricity by placing one or more fluid tubes filled with fluid in the path of a moving object. The force exerted on the fluid is then transferred to a linear actuator. The linear motion of the linear actuator is then converted into rotary motion for driving a motor generator to thereby generate electricity.

It will be appreciated that the energy induced in this fluid tube can be converted to useful electricity at a separate and distant location from that of the “press” zone of interaction of the body in motion, the tire, and the fluid tube, or the sensor.

In addition, the fluid tube, or tubes, must be firmly affixed to the road or near-rail surface for optimal safety, geometrical stability, and energy transfer using fasteners or appropriate epoxies. The power generation can be quite significant and can have the shape of a short high power pulse or a nearly square wave depending on the speed of the moving object and the fluid system design. The extracted energy can be used directly, for example, grid tied or stored in a battery or capacitor system using optimal energy transfer variable impedance, or may be used to generate another by product, such as generate hydrogen through electrolysis.

While several embodiments have been shown and described, the above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert but which can be used independently and/or combined with other features. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

Therefore, it will be understood that the embodiments shown in the drawings and described above are merely for illustrative purposes, and are not intended to limit the scope of the invention which is defined by the claims which follow as interpreted under the principles of patent law including the doctrine of equivalents.

I claim:

1. An energy generation system comprises:
a fluid tube;
a linear actuator configured to be driven by the change in fluid pressure in the fluid tube; and
a motor generator driven by the linear actuator.

2. The energy generation system of claim 1, wherein the linear actuator comprises a cylinder.

3. The energy generation system of claim 2, wherein the cylinder is drivingly coupled to the generator via gearing.

4. The energy generation system of claim 3, wherein the cylinder includes a drive rod with a piston drive that is configured to mesh with the gearing so that when the drive rod is extended the piston drive will drive the gearing to in turn drive the generator.

5. The energy generation system of claim 4, wherein the piston drive comprises a tubular or cylindrical body mounted to the cylinder's shaft, the tubular or cylindrical body including a plurality of openings for meshing with the gearing.

6. The energy generation system of claim 5, wherein the gearing includes a shaft with a sprocket mounted for rotation with the shaft and which also includes a gear for driving the generator.

7. A method of generating energy comprising:
providing a fluid tube filled with a fluid;
applying compression to the tube using a moving object;
converting the change in pressure in the tube resulting from the compression into electricity.

8. The method according to claim 7, wherein said converting includes applying the change in pressure to a cylinder.

9. The method according to claim 8, wherein said converting further includes converting the linear motion of the cylinder that results from the change in pressure into rotary motion.

10. The method according to claim 9, wherein said converting further includes driving a motor generator with the rotary motion.

11. The method according to claim 1, further comprising locating the tube on a roadway in the path of a vehicle.

12. The method according to claim 1, further comprising applying repeated compressions to the tube using a vehicle or a human.
